(19) United States
(12) Patent Application Publication
(10) Pub. No.: US 2025/0272063 A1
(43) Pub. Date: Aug. 28, 2025

(54) INTEGRATED DEVELOPMENT ENVIRONMENT OBJECT MANAGEMENT CODE AUTO-SUGGESTION

(71) Applicant: Zoho Corporation Private Limited, Kanchipuram District (IN)

(72) Inventors: Sridhar Vembu, Tenkasi (IN); Pradeep Kumar Duraisamy Soundrapandian, Sivakasi (IN); Subathra Periakaruppan, Madurai (IN); Siba Mishra, Puri (IN); Shalini Lakshmi A J, Chennai (IN); Vanaja Ramaswamy, Chennai (IN); Punithavathi Palani, Chennai (IN); Joseph Sathya Kumar, Chennai (IN); Akshhayaa S, Guduvanchery (IN); Sudheer A Grandhi, Pleasanton, CA (US)

(73) Assignee: Zoho Corporation Private Limited, Kanchipuram District (IN)

(21) Appl. No.: 19/041,290

(22) Filed: Jan. 30, 2025

Related U.S. Application Data
(60) Provisional application No. 63/631,835, filed on Apr. 9, 2024.

(30) Foreign Application Priority Data
Feb. 23, 2024 (IN) 202441013217
May 6, 2024 (IN) 202441035817

(51) Int. Cl. G06F 8/33

(52) U.S. Cl. CPC G06F 8/33

(57) ABSTRACT

An IDE assists developers using object management functions in programming source code. When a developer enters an object management function, the IDE auto-suggests a draft event handler, populated with any applicable source code templates, customized appropriately. The draft event handler may be edited by the developer when permitted but may be wholly or partially immutable as well. A distributed IDE allows the type definitions, source code templates, and project design discipline to be deployed to multiple developers working on a shared project across an interconnected network. When a developer completes editing, the resultant event handler is accepted and introduced into source code. An override feature allowing a developer to edit immutable sections of the draft event handler may be included. A logging feature is deployed to capture instances of developers overriding a portion of the draft event handler marked immutable.

### FIELD OF THE INVENTION

Embodiments of the present disclosure are related, in general, to computer programming languages and more particularly, but not exclusively, to software development environments.

### CROSS REFERENCE TO RELATED APPLICATIONS

This application is related to Indian Provisional Application 20/244,1013217 filed 23 Feb. 2024, entitled “Integrated Development Environment (IDE) Support For Link Type Object Management”, and U.S. Provisional Application 63/631,835, filed 9 Apr. 2024, and Indian Provisional Application 20/244,1035817, filed 6 May 2024, both entitled “INTEGRATED DEVELOPMENT ENVIRONMENT OBJECT MANAGEMENT CODE AUTO-SUGGESTION”, all of which are incorporated herein by reference.

### BACKGROUND

Modern Integrated Development Environments (IDEs) and compiler systems are sophisticated tools that have revolutionized the way developers create, test, and deploy software. They are designed to streamline the development process, making it more efficient and less error prone.

An IDE is a software suite that consolidates the basic tools needed to write and test software. Modern IDEs come with a source-code editor, build-automation tools, and a debugger. Some also include features like intelligent code completion, syntax highlighting, and code refactoring, which help developers write clean, efficient code. They often support multiple programming languages and provide a unified interface for developers to write, compile, debug, and run their code.

Compiler systems transform the source code written by developers into executable programs. Modern compilers do more than just translate code from one language to another. They also optimize the code to make the resulting program run more efficiently including support for multiple target platforms with different operating systems or hardware architectures. They often come with extensive debugging and profiling tools. These tools help developers identify and fix performance bottlenecks in their code, making it easier to create efficient, high-performance software.

One of the defining characteristics of modern IDEs is their extensibility. They often come with plugin systems that allow developers to add new features or support for additional programming languages. This extensibility makes them adaptable to a wide range of development needs. Furthermore, many IDEs offer cloud-based versions, enabling developers to work from anywhere and collaborate with others in real-time.

At the source code level, user-defined types pertain to structures, classes, interfaces, and other composite data types that programmers define to represent and manipulate complex data structures more effectively. These types go beyond the basic data types like int, float, and char that most languages offer inherently. User-defined types allow for the encapsulation of data and related functionality into cohesive units. At compile time, the compiler checks these types for syntactic and semantic correctness. This includes ensuring that the members of a class or structure are correctly defined, that methods are properly declared and implemented, and that any inheritance or interface implementation is correctly specified. The primary goal during this phase is to ensure that the code adheres to the language's syntax and semantics, and if it doesn't, to provide meaningful feedback to the developer.

Once the source code is compiled and becomes an executable, the user-defined types are transformed into machine code, ready for execution. At runtime, when these types are instantiated, memory is allocated for the resulting objects. For languages with manual memory management like C++, the developer allocates memory for objects using constructs like ‘new’ and releases memory with ‘delete’. In contrast, languages with garbage collection, such as Java or C#, handle memory deallocation automatically once objects are no longer reachable. The runtime environment is responsible for managing the object lifecycle, ensuring that constructors are called when an object is created, and destructors (if applicable) are called when an object is destroyed. The management of these objects and the execution of associated methods form the core of runtime object management based on user-defined types.

### BRIEF DESCRIPTION OF THE DRAWINGS

The subject matter disclosed is illustrated by way of example, and not by way of limitation, in the figures of the accompanying drawings and in which like reference numerals refer to similar elements and in which:

FIG. 1 is a distributed Integrated Development Environment (IDE) 100.

FIG. 2 details an exemplary embodiment of type tree 130 and source code templates 140 in a memory 180.

FIG. 3 is a flowchart of method 300 for populating a type tree and source code templates.

FIG. 4 is an example memory 180 comprising a type tree 130 and source code templates 140 for use in illustrating various methods herein as applied to example code.

FIG. 5 is a flowchart 500 illustrating capturing of user-defined behavioral properties within a type definition and generating source code templates and populating a type tree in response.

FIG. 6 is a flowchart 600 illustrating the generation of a draft event handler for auto-suggestion and editing and incorporating the draft into source code.

FIG. 7 illustrates an example embodiment of distributed IDE 100 including components of a user terminal and shared storage.

### DETAILED DESCRIPTION

A programming language provides for user defined types, which, when compiled, produce instructions for the use of objects of the defined type. Types are defined for use in instantiating objects at runtime. Objects can be affected by object management instructions compiled from object management constructs. Examples are create, update, and delete. Create, update, and delete functionality is built into the example compiler and accessible to developers using the example programming language.

Event handlers are used in programming to perform a set of actions in response to a defined event occurring and can be used in conjunction with object management functions. An event handler may be called prior to performing or subject to completion of an object management function (OMF). An event handler may include instructions that are applicable to a specific object type or instructions that are useful to a group or class of objects. A class of objects may be identified by properties that are inherent in the programming language or may be user defined. Source code templates for all of these sets of instructions can be defined, stored, retrieved, and customized for insertion into an event handler for an object management function operating on an object type.

An IDE is deployed to assist developers using object management functions in programming source code. When a developer, through a user interface to the IDE, enters an object management function operating on an object type in a source code editor, the IDE auto-suggests a draft event handler for that object management function as applied to that object type. The draft event handler will be populated with any source code templates that are applicable to the inherent class of the object type, any source code templates that have been user-defined for a group including the object type, and any source code templates that have been user-defined for the specific object type, each customized appropriately for the object type.

The auto-suggestion of event handlers may be used for convenience of the developer as well as to enforce programming discipline. Therefore, the draft event handler may be edited by the developer when permitted but may be wholly or partially immutable as well. A distributed IDE allowing multiple developers working on a shared project allows the type definitions, source code templates, and project design discipline to be deployed across a network of interconnected developers. When a developer completes editing a suggested draft event handler, where permitted, the resultant event handler is accepted and introduced into the source code. An override feature for allowing a developer to edit immutable sections of the draft event handler may be included in an embodiment. A logging feature is deployed in an embodiment to capture instances of developers overriding a portion of the draft event handler marked immutable.

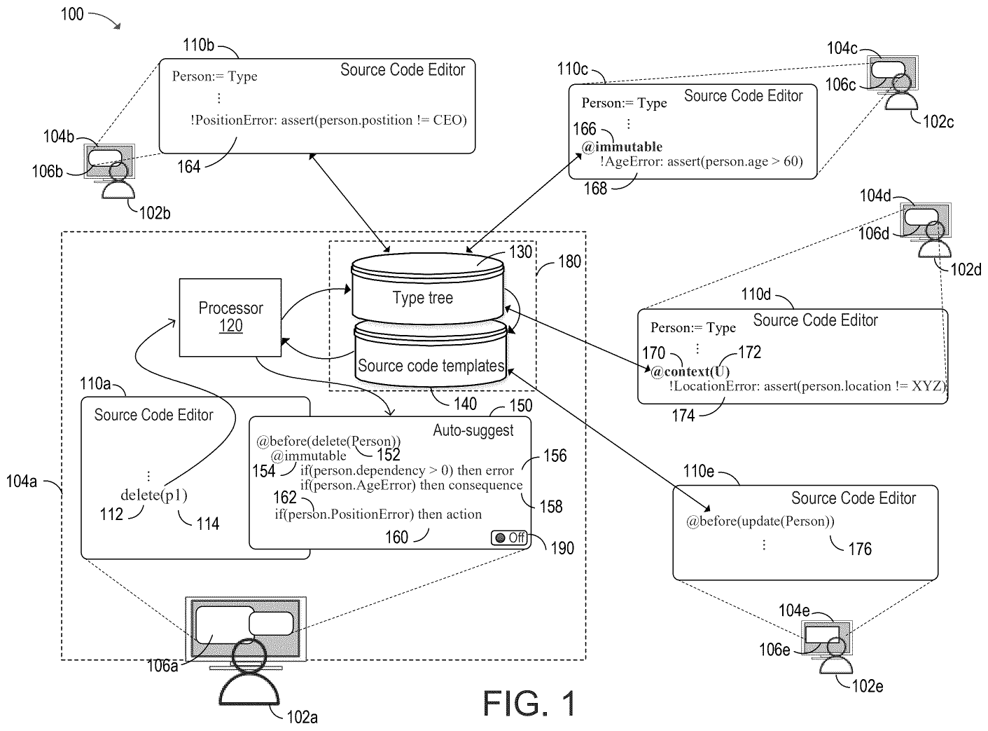

FIG. 1 is a distributed Integrated Development Environment (IDE) 100. Five users 102a-e are equipped with user terminals 104a-e. Each user terminal has a local IDE (106a-e) comprising a source code editor (110a-e). The user terminals 104 are interconnected allowing them to synchronize and share various attributes and pieces of source code between them. Each IDE 106 need not be identical. Various aspects will be illustrated below whereby users 102 edit source code within a shared project.

User terminal 104a comprises processor 120 connected to memory 180. Various applications can be stored in memory 180 for execution with processor 120, including components of IDE 106a. Illustrated here is source code editor 110a in which user 102a is editing source code via a user interface (details not shown). IDE 106a comprises a compiler (not shown), which can be used to compile the source code. Some typical compiler functions, such as parsing the source code, may be carried out by processor 120 via a compiler function, or alternately IDE 106a may incorporate compiler functions to perform the various methods and functions detailed further below.

When user 102a enters an object management construct operating on an object of a defined type into source code editor 110a, processor 120, in concert with memory 180, will present an event handler associated with the object management construct to the user for review, editing, and acceptance into the source code which user 102a is generating. Here a delete construct 112 operating on p1 114, which is an object defined by type Person, is entered into the source code editor 110a. IDE 106a has a data structure comprising the syntax structure and semantic model of all or part of the source code parsed while user 102a is editing, and continually updates the syntax structure and semantic model based on the editing input. In this example, at least the type names and variables of those types from the data structure are parsed into a type tree 130 stored in memory 180. A text extractor component of the IDE extracts keywords which are operated on by a syntax analyzer which, among potentially other analysis functions, determines when an object management function has been entered. When new types or type variables are defined, the type tree 130 is updated with those types or variables. User-defined behavioral properties and IDE directive keywords are also extracted, analyzed, and used to update the type tree 130 and/or generate source code templates.

Source code templates 140 contain templates for use in creating a draft event handler. Source code templates are referenced in various entries in type tree 130. In this example, source code templates for type Person are assembled into a draft event handler 152 and customized with the type Person. The draft event handler 152, for the delete function in this example, is identified by the @before keyword, operating on delete (Person). Using auto-suggestion component 150, the draft event handler 152 is presented to user 102a. In the example embodiment a pop-up window allowing the user to accept, reject, or potentially edit the draft event handler 152 is used. Various alternative methods to allow a user to view and edit an auto-suggested piece of code may be deployed. If the draft event handler 152, as edited if applicable, is accepted by the user it will be incorporated into the source code under development in IDE 106a (and potentially source code of other developers synchronized within IDE 100).

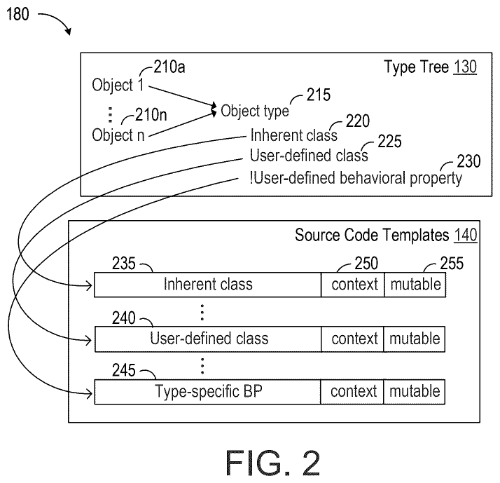

FIG. 2 details an exemplary embodiment of type tree 130 and source code templates 140 in a memory 180. Type tree 130 comprises a collection of one or more object names, Object 1-Object n (210a-n), that are object variables of an object type 215. Type tree 130 may have any number of object types included, with any number of object variable names for each object type. An object type 215 may have references to source code templates stored in source code templates 140, although it is not a requirement. Three types of source code templates are identified in the exemplary embodiment: those for objects in an inherent class based on inherent properties of the type of object 235, those for objects in a user-defined class 240, and those for user-defined templates that are type specific 245.

In the example embodiment, the programming language provides for link types. Link types are defined wherein an Independent Data Type (IDT) is referenced in defining a Dependent-link Data Type (DDT). Examples of link types and dependencies, referred to therein as role sharing types and dependencies, are detailed in U.S. patent application Ser. No. 18/335,035 to Sridhar Vembu et al., filed 14 Jun. 2023, and entitled “Role Extensions For Programming Languages,” which is incorporated herein by reference. Role sharing objects in the '035 application are referred to as linked objects herein. Linked objects may alternately be referred to as link or link-type objects. The types defined to instantiate linked objects are referred to as linked types.

Link types illustrate examples of inherent class. A link type can be an IDT, a DDT, or both. Due to the inherent relationship of linked objects, checks are performed at runtime prior to executing a link-type object management instruction on them. A variety of these checks may be defined for different types and constructs, which are referred to generally as link type criteria. When defined link type criteria are satisfied for a link-type object management instruction for an object at runtime, the instruction is carried out. For example, deletion of an IDT object may be prevented when there are DDT objects dependent on it. Instructions to check dependencies of an IDT object before deletion are applicable across the entire class of IDT types, and so a source code template 235 incorporating those instructions can be stored in source code templates 140.

When an object 210 in type tree 130 is an object type 215 having an inherent class reference 220, DDT in this example, the reference 220 is used to locate the applicable inherent class source code template 235. Each source code template can be associated with a context 250. In the example embodiment, context may include whether the object management function is a create, update, or delete. When preparing a draft event handler, the context 250 can be used to select only the appropriate source code template. A mutability indicator 255 indicates whether the source code template should be identified as mutable or immutable in the draft event handler presented to a developer. In the example embodiment, inherent source code templates for enforcing link type criteria for IDT and DDT objects are marked immutable. Source code templates can be designed generally for all inherent class types applicable to a particular computer programming language. They can also be modified or customized for a particular development team or project as well.

Developers may also identify one or more object types 215 to be part of a user-defined class. User-defined class source code templates 240 may be designed and associated with context 250 and mutability 255 indicators as well. A user-defined class reference 225 associated with an object type 215 is used to locate the appropriate user-defined class template 240 to be incorporated in the draft event handler presented to the developer.

Source code templates 245 are specific to a particular type. In the example embodiment, one or more user-defined behavioral properties (UDBP), identified by the “!” character as a convention, may be defined in that type's definition. These behavioral properties return a Boolean response at runtime to an expression defined in the type definition operating on object elements. A source code template is designed according to the expression to carry out instructions prior to implementing an object management function at runtime. Alternate embodiments may employ other type-specific source code references and templates. A reference 230 associated with object type 215 in type tree 130 can be used to locate a type-specific UDBP source code template 245 to be incorporated in the draft event handler. Type-specific source code templates may be designed for use in a particular context and may be marked immutable as well.

The following code snippet introduces example type definitions used in various illustrations below:
1 Person: =Type #IDT
2 Name: =String
3 Aadhaar: =Number (unique) #ID Structural Property
4 Age: =Number
5
6 Employee: =Person #DDT
7 Designation: =String
9 Room: =Type #IDT
10 RoomNumber: =Number (unique)
11 NetworkID: =Number
12 Size: =Number
13 !UDBP: assert (expression)
14
15 Conference: =Room #DDT
16 Name: =String
17 Occupancy: =Number
18 !UDBP: assert (expression)
19
20 Office: =Room #DDT
21 Occupant: =Employee
22 !UDBP: assert (expression)

Lines 1-4 define Person as a Type. This is an example of an Independent Data Type (IDT) defined with the built-in construct Type. Person has property Name, which is a string, property Aadhaar, which is a number and is defined as a unique property. An Aadhaar is an identification number for people in India. A social security number (SSN) is a similar identifier in the United States. A Person also has numerical property, Age, in this example. In the source code, “: =” denotes a type or element declaration and “:” denotes element or object usage. The use of pascal case (PascalCase) for object and element identifiers indicates a declaration and the use of snake case (snake_case) represents object and element usage. The delimiter “#” identifies comments.

Lines 6-7 define Employee as type Person. Employee is an example of a Dependent-link Data Type (DDT) as it is derived from IDT Person. Employee and Person are link types, as a person object can be instantiated, and an employee object can be linked to that person object. In this example, an employee has property Designation, a string which identifies an attribute for the employee.

The creation or existence of a DDT type instance is dependent on the creation or existence of the corresponding IDT type instance, and the DDT instance or object is linked to the IDT object or instance automatically.

In various examples detailed herein, the IDT Person and DDT Employee are used for illustration. While linked types are quite useful for all sorts of human related roles and activities, they are by no means limited as such. An IDT tool may have a DDT wrench. An IDT vehicle may have a variety of DDT object types, such as a motorbike, automobile, or truck. A hospital may be a DDT of an IDT building. The number of various possible combinations of link types is quite unlimited. Link types are exemplified by the creation and existence of a DDT type object depending on the creation and existence of the corresponding IDT type object, with the DDT object being inherently linked to the IDT object. However, an IDT object can be persistent in memory even after a corresponding DDT is deleted (unless and until the IDT object is deliberately deleted).

Lines 9-11 define another IDT type labeled Room. An object of type Room has three variable elements and a User-defined Behavioral Property (UDBP). The variables include a unique number, RoomNumber, a network identifier number, NetworkID, and a number Size. A generalized UDBP is shown in line 13, called UDBP and identified as a behavioral property by convention with the “!” character. Here the behavioral property asserts a value based on the evaluation of an expression, named expression. In the example embodiment, UDBPs return a Boolean value in response to the expression defined with them. Other behavioral properties are also supported.

Two DDTs of type Room are defined, Conference in lines 15-18 and Office in lines 20-22. A conference room has a string element for its name and a number element indicating the occupancy limit of the room. An office has an Occupant element of type Employee. Each has a generic UDBP for illustrative purposes.

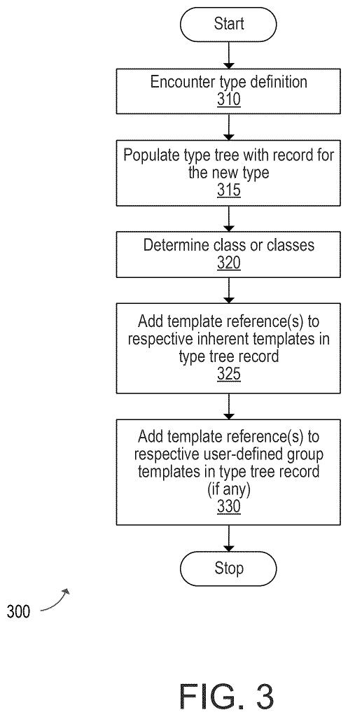

FIG. 3 is a flowchart of method 300 for populating a type tree and source code templates. For each type definition encountered in source code (310) the IDE populates the type tree with a record for the encountered type (315). The IDE then determines the class or classes of which the type definition is a member (320). Inherent class membership is determined according to the aspects of the programming language being used, and optionally in conjunction with a compiling function. In the example embodiment a type may be in the inherent class of IDT, DDT, or both. This is determined from a parse tree showing dependencies between link types. Each type may also be a member of one or more user-defined classes. A variety of techniques can be deployed to determine membership in a user-defined class. For example, a configuration file for a project may be maintained comprising user-defined classes and their type members. Class membership may or may not automatically include dependent types. If a type is determined to be a member of an inherent class for which source code templates are available, then a reference to each applicable source code template is inserted (325) in the type tree 130 for the type. Similarly, if a type is determined to be a member of a user-defined class for which source code templates are available, then a reference to each applicable source code template is inserted (330) in the type tree 130 for the type.

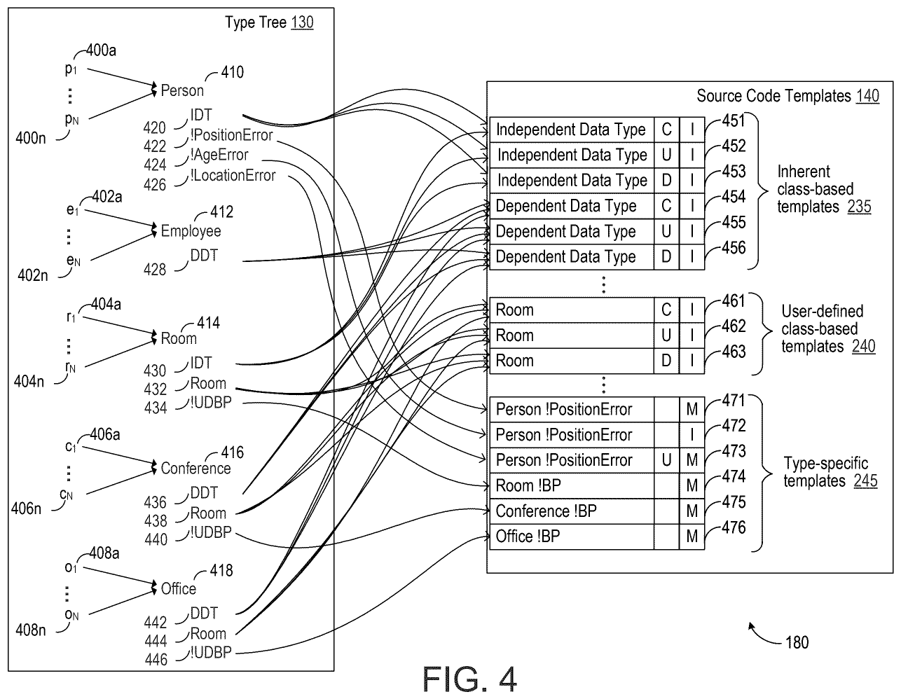

FIG. 4 is an example memory 180 comprising a type tree 130 and source code templates 140 for use in illustrating various methods herein as applied to the example code snippet above. Illustrating method 300, after processing the types encountered (310) in the source code snippet, there are type entries made for the five types (315): Person 410, Employee 412, Room 414, Conference 416, and Office 418. When a variable of a type is declared in source code it is associated with the type in type tree 130. Thus, in this example, there are N variables of type Person p₁-p_{N} (400a-n) associated with the Person entry 410. There are N variables of type Employee e₁-E_{N} (402a-n) associated with the Employee entry 412. There are N variables of type Room r₁-r_{N} (404a-n) associated with the Room entry 414. There are N variables of type Conference c₁-c_{N} (406a-n) associated with the Conference entry 416. There are N variables of type Office o₁-o_{N} (408a-n) associated with the Office entry 418. A type tree 130 can use any data storage technique, including text-based variable names of declared type variables associated with text-based type names. In the example embodiment, as source code is processed in the IDE it is parsed into tokens in a parse tree, including tokens for defined types (410-418) as well as declared variables of those types. When a variable is declared for a type, its token is associated with the token of its defined type. This parse tree association is used to locate types and any associated references to templates in type tree 130. In the example embodiment, the IDE will support link type object definitions, and will be able to determine (320) from parsing the source code to which inherent classes a type belongs (IDT, DDT, or both).

Source code templates 140 (as detailed in FIG. 2) comprise inherent class-based templates 235, user-defined class-based templates 240, and type-specific templates 245. In this example, there are two inherent classes for data types: independent data types (IDT) and dependent data types (DDT). For each inherent class, there are templates defined for each of three object management functions: create, update, and delete. Thus, inherent class-based templates 235 comprise six source code templates: IDT templates for use in the create context 451, the update context 452, and the delete context 453, as well as DDT templates for use in the create context 455, the update context 456, and the delete context 457. In this example, all of the inherent class-based templates are marked immutable.

Referring to method 300, the IDE will determine (320) types Person and Room are IDTs and types Employee, Conference, and Office are DDTs. Adding references to inherent templates (325) results in Person 410 having IDT reference 420 and Room 414 having IDT reference 430 used to access the IDT templates 451-453. Similarly, Employee 412 has DDT reference 428, Conference 416 has DDT reference 436, and Office 418 has DDT reference 442, each reference to access DDT templates 455-457.

User-defined class-based templates 240 are defined for a class labeled Room, which is coincidentally the same name as the IDT Room type and the type of its dependent DDTs. Any grouping of types is supported. A template has been defined for each context of creating (461), updating (462), or deleting (463) an object of the types in the Room class. For illustration, these templates are marked immutable, but each template could be immutable or mutable as desired. Any technique for defining the user-defined classes may be deployed. The IDE uses this information when determining the classes in which a type may be a member (320) and supplying references to user-defined group templates (330). In this example, Room 414 has Room reference 432, Conference 416 has Room reference 438, and Office 418 has Room reference 444, each reference to access Room templates 461-463.

Type-specific templates 245 comprise user-defined behavioral properties for specific types. Type Room 414 has !UDBP reference 434 which is used to access Room !UDBP template 474. In this example, since the context field does not contain an indicator for create, update, or delete, the source code template will be accessed for any of the object management functions applied to that type. Similarly, type Conference 416 has !UDBP reference 440 which is used to access Conference !UDBP template 475, and type Office 418 has !UDBP reference 446 which is used to access Office !UDBP template 476.

Note that in the example code snippet above, there are no UDBPs defined for type Person. Referring back to FIG. 1, the addition of several user-defined behavioral properties for type Person by several different users 102 at their user terminals in the distributed IDE 100 is illustrated. While it is possible to have a single IDE with a type tree 130 and source code templates 140 in a memory 180, in the example embodiment, any number of developers can collaborate within the distributed IDE and synchronize and share source code as well as project definitions and parameters. New type definitions or updates to existing type definitions are synchronized to type tree 130, whether from one or more centralized repositories or utilizing peer-to-peer synchronization, both well known in the art, details omitted.

User 102b is editing the type definition of Person in source code editor 110b. The local IDE 106b utilizes a text extractor component and a syntax analyzer, perhaps in conjunction with a compiler, to determine that a user-defined behavioral property is being entered. !PositionError 164 is captured, which asserts a true value when person.position !=CEO. Note that the Position element does not exist in the Person type definition in the previously introduced code snippet, so user 102b will have entered it (details omitted). A source code template 471 is generated for Person !PositionError. Default source code templates can be designed for a particular project and may incorporate context and mutability as well. In one example, if no default is specified, then a generic if statement with the behavioral property name is presented to the developer, in any context, and is marked mutable for the developer to make any edits desired in accordance with features of the behavioral property. Reference !PositionError 422 is entered for type Person 410 in type tree 130 used to access !PositionError template 471.

In similar fashion, user 102c is editing the Person type, introduces behavioral property 168, !AgeError, which asserts true when person.age>60. In this example, a keyword @immutable 166 is entered prior to the UDBP 168. IDE 100 captures the behavioral property and generates source code template 472. In this example, the @immutable keyword indicates that the mutability marker should be set to immutable. Note that @immutable is a directive to the IDE. As such, it is not a keyword in the underlying programming language, or other keyword used for compiler directives. Examples of compiler directives are detailed in copending U.S. patent application Ser. No. 18/423,784, entitled “Construct-Modification Tags For Development-Phase Compiler Requests,” filed 26 Jan. 2024, by Sridhar Vembu et al., which is incorporated herein by reference (hereinafter the '784 application). An entry for type Person 410 in type tree 130 is made with reference !AgeError 424 used to access !AgeError template 472. The entries to type tree 130 and source code templates 140 are synchronized.

User 104d is also editing type Person. In this illustration, an IDE directive keyword @context 170 is entered with parameter U prior to behavioral property 174, !LocationError, which asserts true when person.location !=XYZ. Note that the Location element does not exist in the Person type definition in the previously introduced code snippet, so user 102d will have entered it (details omitted). This IDE directive keyword causes the corresponding source code template to be generated with the identified context markers, in this case U specifies the property should be presented in the context of an update object management function. Any combination of create (C), update (U), or delete (D) parameters may be supplied to determine context for presenting the template. When @context is not used (as with property 164) then the behavioral property is auto-suggested in all contexts. Reference !LocationError 426 is made for type Person 410 in type tree 130 used to access !LocationError template 473. The entries to type tree 130 and source code templates 140 are synchronized.

A reference to a particular keyword in the methods, systems and devices described herein applies equally to any transformation or alternate representation. The embodiments described herein use IDE directive keywords @immutable and @context chosen to illustrate various aspects of those respective keywords. Those of skill in the art will readily substitute alternate keywords (which may or may not also be illustrative in any language) which simply should be differentiable from keywords of the programming language or languages being employed or other keywords such as compiler directives. Furthermore, parameters supplied to an @context keyword could be substituted by, for example, three specific keywords for create, update, and delete. Context is optional for any template. A template may be used with any number of object management functions, and an object management function need not have any particular template associated with it.

In the example embodiment IDE directive keywords are included in source code for use within the IDE but are not compiled into executable instructions. They may be removed before compilation. Alternatively, a compiler may be designed to ignore IDE directive keywords. An IDE or compiler may alert developers to remove an IDE directive keyword prior to entering the production phase of a software development project (as detailed in the aforementioned '784 application).

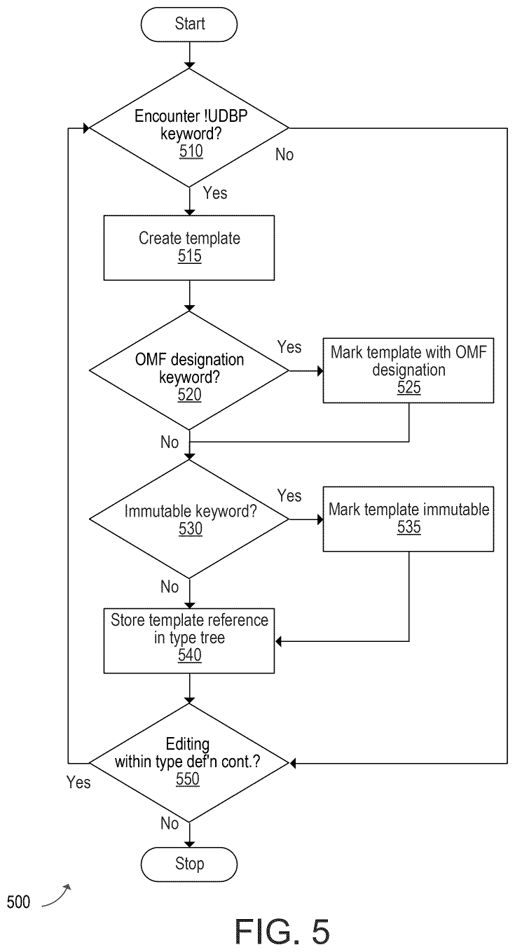

FIG. 5 is a flowchart 500 illustrating capturing of user-defined behavioral properties within a type definition and generating source code templates and populating a type tree in response. The process occurs in the context of a developer entering or editing a type definition within source code (via any input means). Various techniques for detecting when a type definition is being edited are well known in the art. If a !UDBP keyword is not encountered (510), the process proceeds to loop while editing within the type definition continues (550).

If a user-defined behavioral property is encountered (in the example embodiment the !UDBP keyword comprises a variable name for the property preceded by the ! character), then a template for that behavioral property is created (515) and stored in source code templates 140, as illustrated above. If an object management function designation keyword preceded the !UDBP (520), then the created template is marked with the appropriate OMF designation (525). In the example above, @context with parameters C, U, and/or D provide OMF designation.

With no OMF designation (520), or having one and so marked (525), the presence of an associated immutable keyword is checked (@immutable in the exemplary embodiment). If one is found, the template is marked immutable (535). Once marked, or if no immutable keyword is present for the behavioral property, then a reference to the generated template is populated for the type entry in the type tree corresponding to the type being edited (540). If the type continues to be edited (550), the monitoring and analysis continues (510), otherwise the process terminates.

Referring again to FIG. 1, user 102e illustrates the capability of one or more distributed users producing or editing event handler templates for storage in and synchronization with source code templates 140. Here, user 102e using a source code editor 110e, a component of IDE 106e running on user terminal 1104e, is producing an illustrative event handler source code template 176. The @before keyword identifies the event handler applicable to an update object management function for type Person. Source code templates can be created, modified, stored, and synchronized for types identified as inherent classes 235, types in user-defined groups 240, and type specific templates 245.

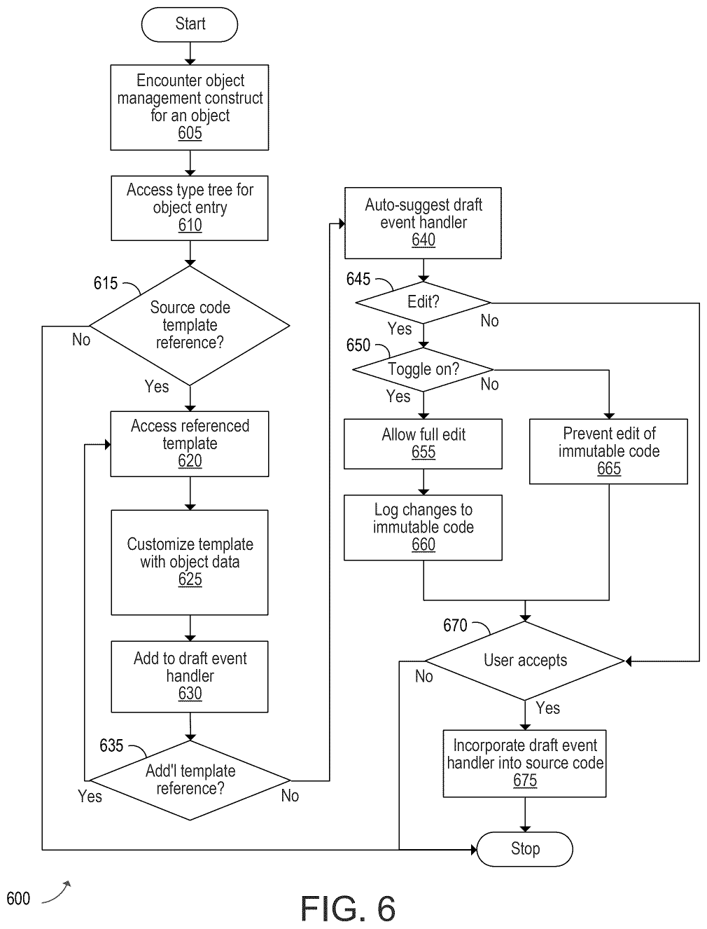

FIG. 6 is a flowchart 600 illustrating the generation of a draft event handler for auto-suggestion and editing and incorporating the draft into source code. The flowchart is described using the example of user 102a editing source code introduced with respect to FIG. 1 above along with the example type tree 130 and source code templates 140 illustrated in FIG. 4.

The process begins with an object management function for an object being encountered (605). Here user 102a is entering a delete 112 operating on a type variable p1 114. Text extractor and syntax analyzer components may be used by processor 120 to determine whether object management functions are encountered. Then type tree 130 is accessed (610) to locate a type variable matching p1 114. In type tree 130, a matching type variable named p1 400a is associated with type Person 410. If the record for the associated type contains one or more source code template references (615), then the referenced template is accessed (620) from source code templates 140. If not, the process stops.

In this example, there are four references in the record for type Person 410. The first is reference 420 indicating that Person is part of the inherent class IDT. This reference identifies IDT source code templates 451-453, each of which has a context (create, update, or delete). Since the object management function encountered is a delete function, only the template matching that context is retrieved (620). The template is customized as appropriate with the type name (625) and added to a draft event handler (630) accounting for the immutable marking of the template. Any type of referencing scheme may be used to reference a source code template from a reference in the type tree. For example, note that context is sorted out of the templates 140, but could have been handled with context specific references in type tree 130 alternatively.

At this point in the example, draft event handler 152 comprises the event handler construct customized for type Person in a delete context, @before (delete (Person)), as well as the operation 156 derived from template 453: if (person.dependency>0) then error. This pseudocode example illustrates one link-criteria aspect: a delete of an IDT should be executed when there are no dependencies to avoid an orphan DDT. Thus, based on this instruction, at runtime, an error will be generated, and the event handler will abort the deletion of the Person object if a dependency exists. The location of operation 156 in the event handler follows the @immutable keyword 154 in accordance with the immutable marking on template 453. A variety of user-interface design techniques may be employed. In an alternate embodiment, immutable code may be a different color than mutable code. The immutable keyword may be omitted when another mutability marker is employed.

Other link-type template operation examples include checking for the existence of an IDT object prior to creating one in response to an IDT create object management function, and only creating the object when it is not found. A check for existence of an associated DDT object may be made in response to a create IDT object management function, with the consequence that the IDT object is created if not found. Thus, generating an error in an event handler is just one of the many options available. Any number of operations may be incorporated in an event handler, and therefore those operations may be designed into corresponding event handler templates as well.

Event handlers for link type object management comprising additional example link-type criteria instructions and other techniques to regulate link type object management at runtime are detailed further in several copending patent applications.

A compile-time link type manager may ensure that all link type object management constructs have associated event handlers at compile time, and that such an event handler meets certain criteria for the particular link type. An example compile-time link type manager enforcing source-code defined event handlers is detailed in copending U.S. patent application Ser. No. 18/405,699, entitled “Compile-time Link Type Object Management,” filed on 5 Jan. 2024, by Sridhar Vembu et al., which is incorporated herein by reference (hereinafter the '699 application).

Embodiments detailed in the '699 application can be combined with other object management techniques. For example, built-in object management functions are extensible to include link-type criteria in the type definition in source code. Extensible built-in object management functions are detailed in copending U.S. patent application Ser. No. 18/406,003 entitled “Extensible Built-In Object Management,” filed on 5 Jan. 2024, by Sridhar Vembu et al., which is incorporated herein by reference (hereinafter the '003 application).

In an alternate embodiment, an event handler in source code is not required, as a general-purpose runtime object management engine is provided for affecting link-type objects at runtime that may include one or more of the desired link-type criteria built in. Example embodiments are detailed in copending U.S. patent application Ser. No. 18/405,916, entitled “Runtime Support for Link Type Object Management,” filed on 5 Jan. 2024, by Sridhar Vembu et al., which is incorporated herein by reference (hereinafter the '916 application).

Example link-type criteria includes determining the existence of an IDT object, determining whether a dependency such as a DDT object exists, and evaluation of constraints specific to an object management function (e.g., create, update, or delete) or specific to a link object type (e.g., IDT or DDT). Link-type criteria can be evaluated in different phases. For example, an event handler, as just described, may be used to evaluate criteria prior to an object management function execution, like determining whether an IDT object exists prior to creating an object dependent on that object. Other link-type criteria may be evaluated during an object management function, using object management extensions as detailed in the '003 application.

Returning to FIG. 6, if there are additional references associated with the encountered type (635), the process loops back to access the appropriate template (620). Here, the second reference for Person 410 is for UDBP !PositionError 422, from which template 471 may be accessed. Note that the context field for template 471 is blank, so it will be retrieved for any context (in this embodiment). The customized template (625) is added to the draft event handler (630). Referring again to FIG. 1, as this template was marked mutable, it is placed outside the source code area delineated by an immutable marker, such as @immutable, or displayed in a color associated with mutability. Here the customized operation 160 accesses the Boolean result of behavioral property person.PositionError 162 and performs an action when the result is true.

The process continues (635) to retrieve template 472, accessed using !AgeError reference 424. The context field for template 471 is blank, so it will be retrieved for any context (in this embodiment). The customized template (625) is added to the draft event handler (630) in accordance with its having been marked immutable with the @immutable keyword entered by user 102c. Customized operation 158 performs a consequence when person.AgeError results in a true value.

The process continues once more (635), but here the final reference for Person, !LocationError 426, refers to template 473, which has been given a specific context U for update. Since the example object management function here is a delete, the template will not be retrieved or added to the draft event handler. Having exhausted the possible template references (635), the auto-suggestion component displays the draft event handler to the user for review (640).

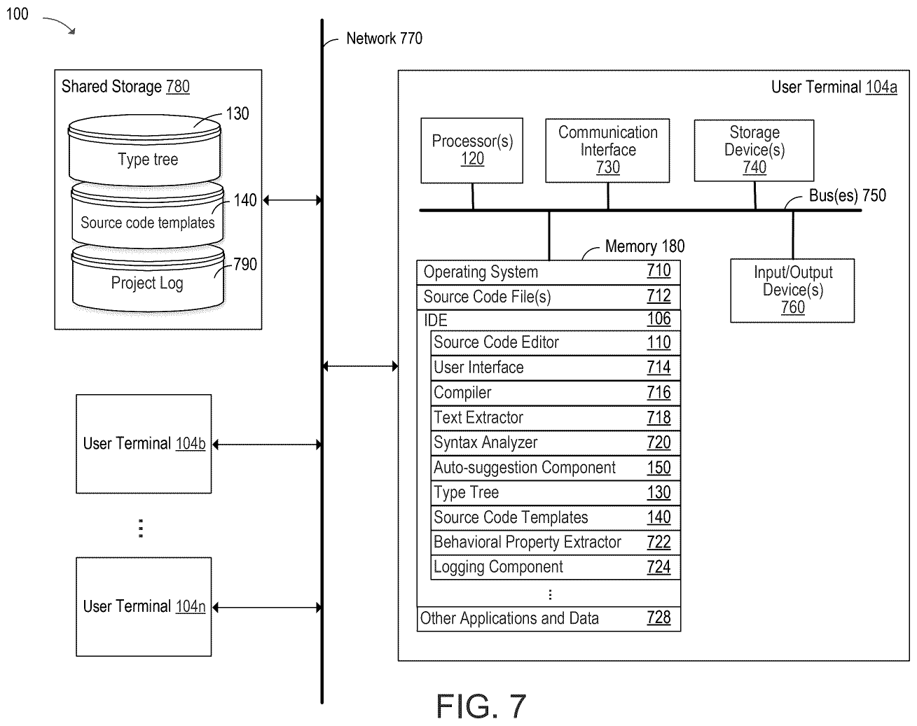

In the example embodiment, the auto-suggestion component presents the draft event handler in an editable source code window, as shown in FIG. 1. The user may make any edits to the mutable portion of the event-handler draft code by default. This may include changing an action defined in response to a user-defined behavioral property, or defining one if the template did not already include one. In FIG. 1, a toggle switch (reading Off) is deployed in the lower right corner of the auto-suggest 150 window. When this is set to Off, then the user is unable to edit any code marked immutable. This toggle may be turned On to allow editing of the entire code, which may require the user to have certain permissions to do so. In one embodiment, when the user hovers a mouse over or otherwise selects a user-defined behavioral property, such as person.PositionError 162 in the example shown, the definition of the behavioral property is displayed to the user for convenience (that information would otherwise be available in the portion of code having the type definition of Person). A toggle, such as toggle 190 in one embodiment, may allow or disallow the editing of the behavioral property displayed. When a user overrides an immutable marking on one or more pieces of the draft event handler, those changes are logged in a log file for the project (e.g. project log 790, detailed with respect to FIG. 7 below). Once the user has been presented with the draft and optionally made any desired edits, the user may accept or reject the draft. If accepted, the draft event handler is incorporated into the source code. If rejected, the event handler will not be incorporated in the source code. In the example embodiment, rejecting a draft event handler having one or more immutable portions will prevent the use of the object management function in source code, unless the override toggle 190 is set (and the rejection of the use of an event handler will be recorded in the log.

These aspects are illustrated in flowchart 600, where if the user makes edits (645) then if the toggle 190 is on (650) full editing is allowed (655) and any changes to immutable code will be flagged (660) for logging. If the toggle 190 is off, then the auto-suggestion component prevents changes to code marked immutable (665). In either case, or if the user declined to make edits at all (645), the user may accept the code (670) and the draft event handler, as edited, will be incorporated into source code and any flagged changes will be logged (675). Then the process stops.

If the user decides to reject the handler (670), then the draft event handler will not be incorporated into source code and any edits will be discarded. If the event handler comprises immutable code, then unless the user has other permission (e.g. toggle 190 is on) the object management function encountered will be disabled in the source code (and if this behavior is overridden the action will be logged). Then the process stops.

FIG. 7 illustrates an example embodiment of distributed IDE 100 including components of a user terminal and shared storage. Here user terminal 104a is connected via network 770 with other user terminals 104b-n, shared storage 710, and optionally any other device (not shown). However, it should be noted that IDE operating environment and the aspects disclosed herein are not constrained to any particular configuration of devices.

User terminals 104a-n may be any type of electronic device, such as, without limitation, a mobile device, a personal digital assistant, a mobile computing device, a smart phone, a cellular telephone, a handheld computer, a server, a server array or server farm, a web server, a network server, a blade server, an Internet server, a work station, a mini-computer, a mainframe computer, a supercomputer, a network appliance, a web appliance, an Internet-of-Things (IoT) device, a distributed computing system, multiprocessor systems, or combination thereof. A user terminal may be configured utilizing a cloud service. The operating environment of IDE 100 may be configured in a network environment, a distributed environment, a multi-processor environment, or a stand-alone computing device having access to remote or local storage devices.

User terminals 104 may include one or more processors 120, a communication interface 730, one or more storage devices 740, one or more input/output devices 760, and a memory 180. A processor 120 may be any commercially available or customized processor and may include multi-processor architectures. The communication interface 730 facilitates wired or wireless communications between the computing devices such as user terminals 104 and other devices. The components of a user terminal 104 are communicatively coupled via one or more buses 750.

A storage device 740 may be a computer-readable medium that does not contain propagating signals, such as modulated data signals transmitted through a carrier wave. Examples of a storage device 740 include without limitation RAM, ROM, EEPROM, flash memory or other memory technology, CD-ROM, digital versatile disks (DVD), or other optical storage, magnetic cassettes, magnetic tape, magnetic disk storage, all of which do not contain propagating signals, such as modulated data signals transmitted through a carrier wave. There may be multiple storage devices 740 in the computing devices 104. The input/output devices 760 may include a keyboard, mouse, pen, voice input device, touch input device, display, speakers, printers, etc., and any combination thereof.

A memory 180 may be any non-transitory computer-readable storage media that may store executable procedures, applications, and data. The computer-readable storage media does not pertain to propagated signals, such as modulated data signals transmitted through a carrier wave. It may be any type of non-transitory memory device (e.g., random access memory, read-only memory, etc.), magnetic storage, volatile storage, non-volatile storage, optical storage, DVD, CD, floppy disk drive, etc., A memory 180 may also include one or more external storage devices or remotely located storage devices.

The memory 180 may contain instructions, components, and data. A component is a software program that performs a specific function and is otherwise known as a module, program, and/or application. The memory 180 may include an operating system 710, one or more source code files 712, an IDE 106 and other applications and data 728. IDE 106 may include a source code editor 110, a user interface 714, a compiler 716, a text extractor 718, a syntax analyzer 720, an auto-suggestion component 150, a type tree 130, source code templates 140, a behavioral property extractor 722, and a logging component 724.

User terminal 104 may utilize an integrated development environment (IDE) 106 that allows a user (e.g., developer, programmer, designer, coder, etc.) to design, code, compile, test, run, edit, debug, or build a program, set of programs, web sites, web applications, and web services in a computer system. Software programs can include source code files 712, created in one or more source code languages (e.g., Visual Basic, Visual J #, C++. C#, J #, Java Script, APL, COBOL, Pascal, Eiffel, Haskell, ML, Oberon, Perl, Python, Scheme, Smalltalk and the like, as well as proprietary or custom-designed programming languages). The IDE 106 may provide a native code development environment or may provide a managed code development that runs on a virtual machine or may provide a combination thereof. The IDE 106 may provide a managed code development environment using a framework such as Java SE, .NET, Node.js, Python Frameworks such as Django, Flask, etc., Ruby on Rails, PHP Frameworks such as Laravel, Symfony, etc., React, and others. It should be noted that this operating environment embodiment is not constrained to providing the source code development services through an IDE and that other tools may be utilized instead, such as a stand-alone source code editor and the like.

A user can create and/or edit the source code files 712 according to known software programming techniques and the specific logical and syntactical rules associated with a particular source language via a user interface 714 and a source code editor 110 in the IDE 106. Thereafter, the source code files 712 can be compiled via a compiler 716, such as a front end or language compiler. During this compilation process, the front-end compiler 716 generates data structures representing the syntactic structure and semantic model of the source code.

Local type tree 130 and source code templates 140 in memory 180 in each user terminal 104 may be shared and synced with each other via peer-to-peer synchronization, or with like named and numbered components in shared storage 710. A project log 790 may be included in shared storage 710 to store, among other data, changes made to suggested draft event handlers.

The user terminals 104 may be communicatively coupled via network 770. The network 770 may be configured as an ad hoc network, an intranet, an extranet, a virtual private network (VPN), a local area network (LAN), a wireless LAN (WLAN), a wide area network (WAN), a wireless WAN (WWAN), a metropolitan network (MAN), the Internet, a portions of the Public Switched Telephone Network (PSTN), plain old telephone service (POTS) network, a wireless network, a WiFi® network, or any other type of network or combination of networks.

The network 770 may employ a variety of wired and/or wireless communication protocols and/or technologies. Various generations of different communication protocols and/or technologies that may be employed by a network may include, without limitation, Global System for Mobile Communication (GSM), General Packet Radio Services (GPRS), Enhanced Data GSM Environment (EDGE), Code Division Multiple Access (CDMA), Wideband Code Division Multiple Access (W-CDMA), Code Division Multiple Access 2000, (CDMA-2000), High Speed Downlink Packet Access (HSDPA), Long Term Evolution (LTE), Universal Mobile Telecommunications System (UMTS), Evolution-Data Optimized (Ev-DO), Worldwide Interoperability for Microwave Access (WiMax), Time Division Multiple Access (TDMA), Orthogonal Frequency Division Multiplexing (OFDM), Ultra-Wide Band (UWB), Wireless Application Protocol (WAP), User Datagram Protocol (UDP), Transmission Control Protocol/Internet Protocol (TCP/IP), any portion of the Open Systems Interconnection (OSI) model protocols, Session Initiated Protocol/Real-Time Transport Protocol (SIP/RTP), Short Message Service (SMS), Multimedia Messaging Service (MMS), or any other communication protocols and/or technologies.

The foregoing description of the implementations of the present techniques and technologies has been presented for the purposes of illustration and description. This description is not intended to be exhaustive or to limit the present techniques and technologies to the precise form disclosed. Many modifications and variations are possible in light of the above teaching. It is intended that the scope of the present techniques and technologies are not limited by this detailed description. The present techniques and technologies may be embodied in other specific forms without departing from the spirit or essential characteristics thereof. The modules, routines, features, attributes, methodologies, and other aspects of the present disclosure can be implemented as software, hardware, firmware, or any combination of the three. Also, wherever a component, an example of which is a module, is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present techniques and technologies are in no way limited to implementation in any specific programming language, or for any specific operating system or environment. Accordingly, the disclosure of the present techniques and technologies is intended to be illustrative, and not limiting. Therefore, the spirit and scope of the appended claims should not be limited to the foregoing description. In U.S. applications, only those claims specifically reciting “means for” or “step for” should be construed in the manner required under 35 U.S.C. § 112 (f).

What is claimed is:

1. A method comprising:
generating a data structure that tracks a syntax structure and semantic model of a source code program in a source code editor, the data structure comprising:
a record for each of one or more type names; and
one or more type variable names, each type variable name associated with one of the type names;
encountering in the source code program an object management construct comprising an object management function directed to a type variable;
accessing in the data structure the record for the type name associated with the type variable name;
finding in the record a reference to one of a plurality of templates;
retrieving the one template from the plurality of templates; and
composing an event handler construct for the object management construct comprising the one template.

2. The method of claim 1, wherein a type definition with the type name defines an object with an inherent property based on the programming language of the source code program, and the reference in the record is associated with the one template having instructions based on the inherent property.

3. The method of claim 1, wherein a type definition with the type name defines an object, the object a member of a user-defined group of objects, and the reference in the record is associated with the one template having instructions designed for the user-defined group of objects.

4. The method of claim 1, wherein a type definition with the type name comprises a behavioral property, and the reference in the record is associated with the one template having instructions responsive to the behavioral property.

5. The method of claim 1, further comprising modifying the event handler construct with the type name.

6. The method of claim 1, further comprising presenting the event handler construct in an auto-suggest editor.

7. The method of claim 6, wherein the auto-suggest editor allows modification of the one template.

8. The method of claim 6, wherein the one template of the event handler construct is marked immutable, the method further comprising preventing modification of the one template.

9. The method of claim 6, wherein the one template of the event handler construct is marked immutable and the auto-suggest editor comprises a toggle, the method further comprising preventing modification of the one template when the toggle is set to a first value and allowing modification of the one template when the toggle is set to a second value.

10. The method of claim 6, further comprising:
encountering an acceptance of the event handler in the auto-suggest editor; and
incorporating the event handler into the source code program.

11. The method of claim 1, wherein:
the reference in the record is associated with the one of and a second of the plurality of templates, the one template marked for a first context, the second template marked for a second context;
the object management function is encountered in a source code context; and
the retrieving of and composing with the one template is responsive to the source code context matching the first context.

12. The method of claim 11, further comprising:
retrieving the second template from the plurality of templates responsive to the source code context matching the second context; and
composing the event handler construct comprising the second template responsive to the source code context matching the second context.

13. The method of claim 1, further comprising:
encountering in the source code program a user-defined behavioral property of a second type;
generating a third template incorporating the user-defined behavioral property; and
appending a reference to the third template to the record for the second type.

14. A system comprising:
one or more processors coupled to a memory; and
one or more programs, wherein the one or more programs are stored in the memory and configured to be executed by the one or more processors, the one or more programs including instructions that:
generate a data structure that tracks a syntax structure and semantic model of a source code program in a source code editor, the data structure comprising:
a record for each of one or more type names; and
one or more type variable names, each type variable name associated with one of the type names;
encounter in the source code program an object management construct comprising an object management function directed to a type variable;
access in the data structure the record for the type name associated with the type variable name;
find in the record a reference to one of a plurality of templates;
retrieve the one template from the plurality of templates; and
compose an event handler construct for the object management construct comprising the one template.

15. The system of claim 14, wherein a type definition with the type name defines an object with an inherent property based on the programming language of the source code program, and the reference in the record is associated with the one template having instructions based on the inherent property.

16. The system of claim 14, wherein a type definition with the type name defines an object, the object a member of a user-defined group of objects, and the reference in the record is associated with the one template having instructions designed for the user-defined group of objects.

17. The system of claim 14, wherein a type definition with the type name comprises a behavioral property, and the reference in the record is associated with the one template having instructions responsive to the behavioral property.

18. The system of claim 14, wherein the one or more programs further comprise instructions that present the event handler construct in an auto-suggest editor comprising a toggle, wherein the auto-suggest editor allows modification of the one template when the event handler construct is not marked immutable, or when the event handler construct is marked immutable and the toggle is set to a first value, and the auto-suggest editor prevents modification of the one template when the event handler is marked immutable and the toggle is set to a second value.

19. The system of claim 14, wherein the reference in the record is associated with the one of and a second of the plurality of templates, the one template marked for a first context, the second template marked for a second context;
the object management function is encountered in a source code context; and
the retrieving of and composing with the one template is responsive to the source code context matching the first context.

20. A system for generating source code comprising:
one or more source code templates, each source code template identified by a reference;
one or more type variables, each type variable associated with one of a plurality of data types, at least one of the plurality of data types associated with one or more source code references;
a user interface for encountering an object-management construct directed to one of the type variables, the type variable identifying the associated data type for defining an object, the object-management construct defining object-management instructions for affecting the object; and
a processor for generating, responsive to encountering the object-management construct, an event-handler construct comprising the one of the source code templates identified by the source code reference associated with the identified data type, the event-handler construct defining event-handler instructions for execution prior to execution of the object-management instructions at runtime.
